(19) United States
(12) Patent Application Publication
(10) Pub. No.: US 2025/0386775 A1
(43) Pub. Date: Dec. 25, 2025

(54) GARDEN FRAMING APPARATUS

(71) Applicant: Ryan Risko Cothran, Philadelphia, PA (US)

(72) Inventor: Ryan Risko Cothran, Philadelphia, PA (US)

(21) Appl. No.: 18/750,954

(22) Filed: Jun. 21, 2024

(51) Int. Cl. A01G 9/12

(52) U.S. Cl. CPC A01G 9/28; A01G 9/026

(57) ABSTRACT

A garden frame for providing protection and stabilization to plants is provided. The garden frame includes framing material having a cylindrical shape and a sidewall for loading plants in a hallow interior space. The closure of the sidewall and the inward movement of a beveled circular edge attached to a base load the plants in the garden framing apparatus. The sidewall is therefore locked in a closed position by aligning a plurality of perforations with a plurality of fastening mechanisms provided thereon.

### FIELD OF THE INVENTION

The present disclosure is directed towards the construction and design of a garden frame. More particularly, the subject matter is the means by which a garden frame provides protection and stabilization to plants in a durable and flexible material with novel plant-retaining elements.

### BACKGROUND OF THE INVENTION

Planters of various configurations for protecting plants are well known in the art. Many of such planters are rectangular in form and provide structural and irrigation support. In some cases, the planters are presented as a plurality of stackable or non-stackable containers with some form of a self-supporting column.

Some of the modular planting variations include planter units that are stacked together into vertical configurations and the plants having access to proper feeding and growth medium project in continuous vertical configurations. Additional variations include tiered flowerpots with centralized upright poles for support and identical growing containers and that are vertically stackable and self-aligning.

These and additional variations of planters do not provide the mobility, durability, and protection for plants. The current invention effectively addresses these and other limitations.

The garden frame of the present disclosure is further characterized with the following novel features: (1) A garden frame for encasing plants and wherein the garden frame features a durable and a flexible framing material with an outer cylindrical shape; (2) The bottom surface of the frame is fixedly connected to a base having a beveled edge for loading the plants in the interior space of the garden frame; and (3) The sidewall of the garden frame having a first portion with a plurality of perforations that align with a plurality of fastening mechanisms formed on a second portion thereof for adjustably closing the frame and enclosing the plants.

### SUMMARY

In order to accomplish the objectives of the present disclosure, there is provided a garden frame for encasing plants using a durable and a flexible framing material with an outer cylindrical shape. In an embodiment, the bottom surface of the frame is fixedly connected to a base having a beveled edge for loading the plants in the interior space thereof. The sidewall 19 of the frame is adjusted and closed with a plurality of fastening mechanisms formed on a first and a second portion thereof to enclose the plants as the the base overlaps to form a circular opening in the bottom surface.

Unless otherwise defined, all technical and scientific terms used herein have the same meaning as commonly understood by one of ordinary skill in the art. Although methods and materials similar or equivalent to those described herein can be used in the practice or testing of any described embodiment, suitable methods and materials are described below. In addition, the materials, methods, and examples are illustrative only and not intended to be limiting.

In case of conflict with terms used in the art, the present specification, including definitions, will control. The foregoing summary is illustrative only and is not intended to be in any way limiting. In addition to the illustrative aspects, embodiments, and features described above, further aspects, embodiments, and features will become apparent by reference to the drawings and the following detailed description and claims.

### BRIEF DESCRIPTION OF THE DRAWINGS

The present embodiments are illustrated by way of the figures of the accompanying drawings, which may not necessarily be to scale, in which like references indicate similar elements, and in which:

FIG. 1 is a top perspective view of a garden frame showing a possible layout thereof including a flexible framing material and a plurality of fastening mechanisms to reinforce the closure of the sidewall;

FIG. 2 is a bottom perspective view thereof showing the overlap of the first and the second portions of the sidewall;

FIG. 3 is a perspective view thereof showing the sidewall in an opened position and the vertical slit provided between the first and the second portions thereof;

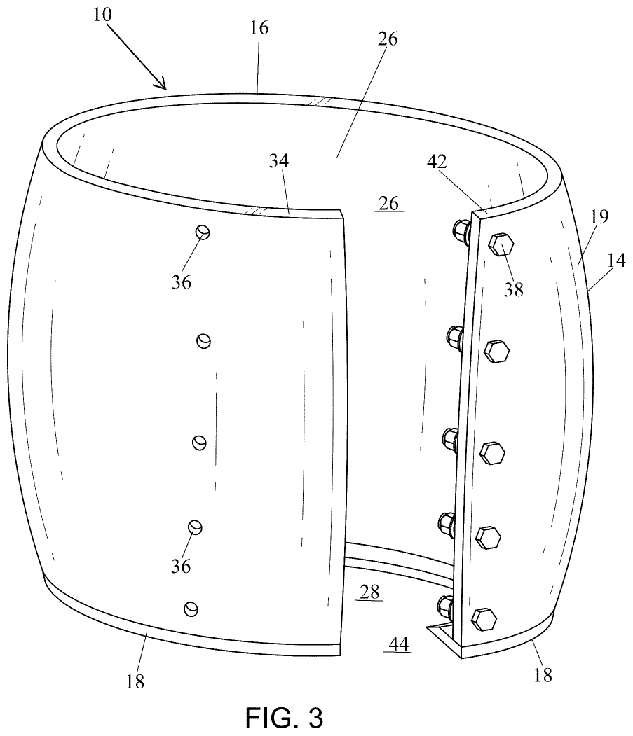

FIG. 4 is a perspective view thereof showing the garden frame in a closed position and housing plants in the hallow interior space;

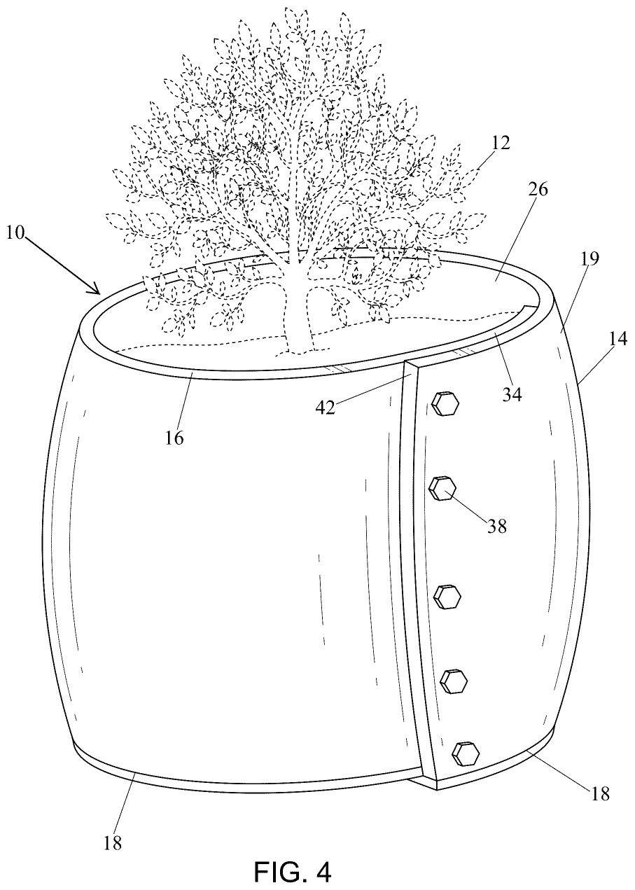

FIG. 5 is an exemplary representation thereof showing the flexibility required for the garden frame;

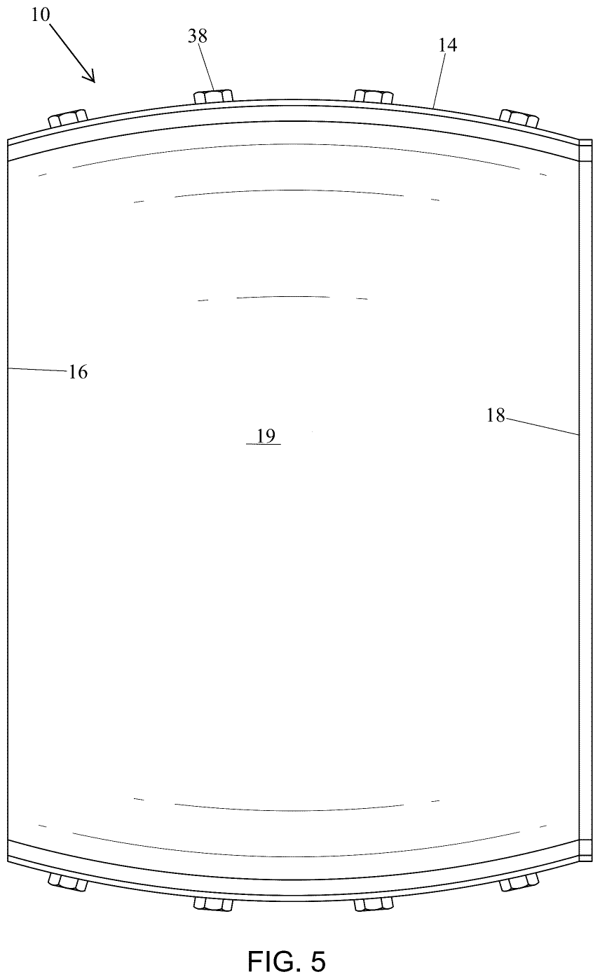

FIG. 6 is an alternative layout thereof showing a plurality of the garden frames and the alignment of each garden frame relative to each other for alignment of the plurality of perforations to the fastening mechanisms of the sidewall; and

FIG. 7 is an alternative layout thereof showing a plurality of the garden frames being adjustably connected.

### DETAILED DESCRIPTION

The following detailed description is the best-contemplated mode of carrying out the disclosure. Although the disclosure has been explained in relation to its preferred embodiment, it is to be understood that many other possible modifications and variations can be made without departing from the spirit and scope of the invention.

Therefore, the garden frame 10 may be used in various types of settings including residential homes, community gardens, agricultural environments, public parks, and the same to provide a versatile solution for gardening and landscape activities.

In situations where multiple use is desired, the garden frame 10 can be used as line planters along a driveway or walkway to draw attention toward a home, framing for a front entrance by placing the garden frame on each side, decorative placements on retaining walls, or arrangements provided side-by-side in a garden.

Once installed, the garden frame 10 provides the opportunity to create a structured garden space while promoting the growth of plants, improving the aesthetics of a growing space, and promoting a connection with nature in a broad range of environments.

The framing material 14 can be constructed from layers of fabric, rubber and steel wires, bendable plastic materials, polyethylene plastic sheeting, fiberglass, or any material that is resistant to erosion and changes in the weather. It is preferably in the form of a tower-like, protective, and insulating wrap that encourages proper growth of plants 12. The sidewall is preferably conical-shaped and extending upwards from the base 22.

The fastening mechanisms 38 are preferably made of metal, but other materials such as plastic, wood, rubber, composite materials, magnets, or the same could be used for fastening the garden frame 10. As will be recognized by those skilled in the pertinent art, various types of fastening mechanisms 38 including nuts and bolts, screws, clamps, rivets, adhesives, zip ties, or the same can be used to secure the sidewall 19 of the garden frame 10. It may be necessary to reinforce the garden frame 10 wherein the base 22 can be laid in the ground, provided in movable elongated surfaces, aligned with buildings, or constructed in similar reinforced locations.

In one embodiment, the vertical slit 44 is provided between first 34 and second portions 42 of the sidewall 19 and extends vertically from the top surface 16 to the bottom surface 18 of the garden frame 10. The sidewall 19 can be amended to address the needs of specific plants 12 encased therein. For example, a second slit extending horizontally sideward from the first vertical slit 44 can be installed. The sidewall 19 can be further widened to create additional access to the plants 12 or to create watering, drip, and viewing holes.

The types of plants 12 associated with the garden frame 10 therewith can be varieties of live plants in growing medium, root vegetables such as carrots and turnips, rooted and unrooted cuttings, grafts, seedlings, and various types of plant growth arrangements. The garden frame 10 provided herein can also be used to house dirt and garden waste filled up to the top surface 16 of the sidewall 19.

It is contemplated that the description, taken with the drawings, makes apparent to those skilled in the art how an embodiment of the disclosure may be practiced. Variations of this embodiment may include, but are not limited to, additional or fewer perforations 36 and fastening mechanisms 38, or a differently shaped vertical slit 44. For example in an embodiment with additional or fewer perforations 36 and fastening mechanisms 38, closure mechanisms adapted for a secured lateral placement along the first 34 and second portion 42 of the sidewall 19 can be used.

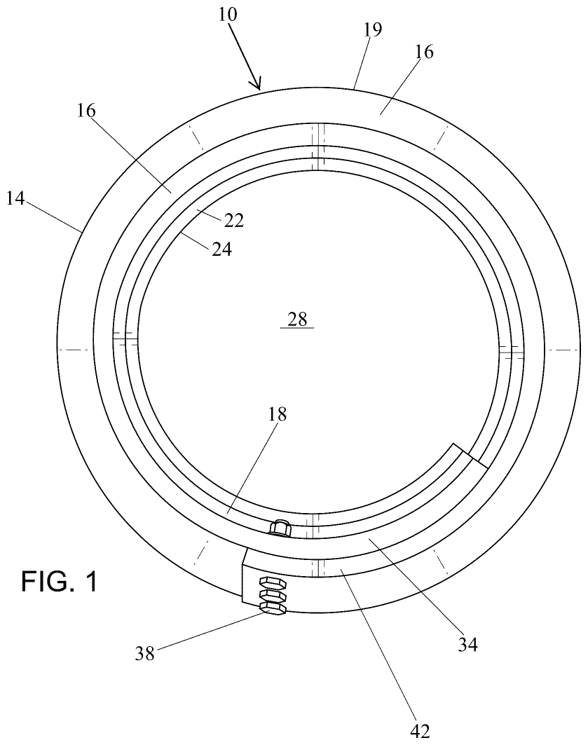

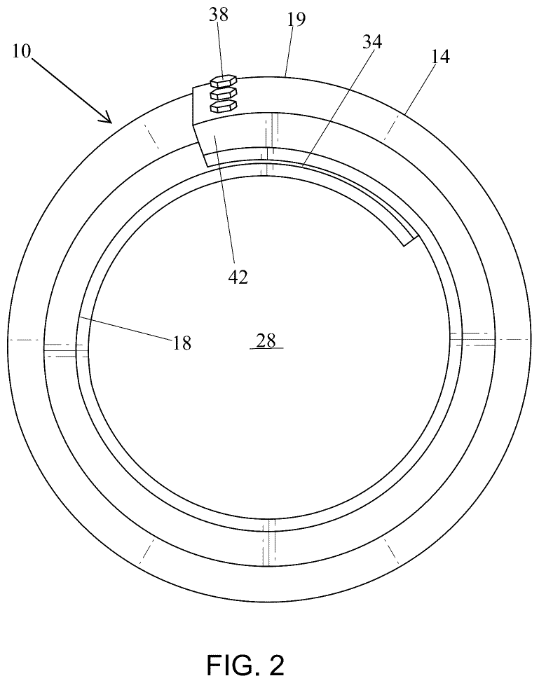

Referring now to FIGS. 1 and 2, a garden frame framing apparatus 10 for providing protection and stabilization to plants 12 in a durable and flexible frame with novel plant-retaining elements is shown.

The garden frame 10 comprises a cylindrical structure 14 having a top surface 16, a bottom surface 18, a sidewall 19, and a hollow interior space 28. A base 22 is fixedly connected to the bottom surface 18 along an inner surface 26 of the sidewall 19.

The base 22 having a beveled edge 24 extending a distance into the hollow interior space 28 of the garden frame 10. The sidewall 19 having a first portion 34 with a plurality of perforations 36 and a second portion 42 with a plurality of fastening mechanisms 38.

The perforations 36 align with the fastening mechanisms 38 to close the sidewall 19 and enclose the plants 12 in the hollow interior space 28. The sidewall 19 is configured in an upright orientation and includes a vertical slit 44 defined between the first portion 34 and the second portion 42. The vertical slit 44 Extends from the top surface 16 to the bottom surface 18 and wherein the first portion 34 of the sidewall 19 overlaps with the second portion 42 of the sidewall 19 when the sidewall 19 is closed.

The base 22 overlaps to form a circular opening at the bottom surface 18 when the first portion 34 overlaps the second portion 42 and the garden frame 10 is closed and wherein the plants 12 are loaded into the hollow interior space 28 of the garden frame 10 by closing the vertical slit 44 and securing the first portion 34 to the second portion 42 of the sidewall 19 via the fastening mechanisms 38, thereby causing the beveled edge 24 of the base 22 to encase the plants 12 against the sidewall 19 of the garden frame 10.

The sidewall 19 of the garden frame 10 is flexible and configured to allow rotational and linear adjustment to position and retain the plants 12 within the hollow interior space 28 of the garden frame 10 in an upright configuration. The sidewall 19 of the garden frame 10 is thereby comprised of durable and weather-resistant material.

The base 22 is thereby a central support mechanism facilitating the downward flow of nutrients and water in the direction of the bottom opening formed between the circular beveled edge 24. The beveled edge 24 features a blade-like configuration for engaging the bottom areas of plants 12 positioned in the apparatus 10. It functions as a sturdy underlying wall such that the garden frame 10 stabilizes the plants 12 that are enclosed therein.

In the case of live pants, the interior 28 of the sidewall 19 functions as a root barrier, meaning that the interior surface 28 is not susceptible to root penetration, weathering, or decay. The base 22 further allows for the draining of fluids and facilitates a circular closure wherein the plants 12 are easily unwrapped from the garden framing apparatus 10.

The garden frame 10 is configured for use as a plant-encasing boundary. It is flexible, durable, weather-resistant, and adaptable for rotational and linear movement and for retaining the plants 12 in a spaced elevational configuration in the garden framing apparatus 10. It is a protective layer that is bendable to allow the sidewall 19 to be adjusted to raise, lower, or improve the contact of the plants 12 with the interior space 28 or a bottom surface 18. It is further bendable in vertical or angled directions to achieve a desired configuration or in response to changing temperatures, water levels, rain, or similar weather conditions.

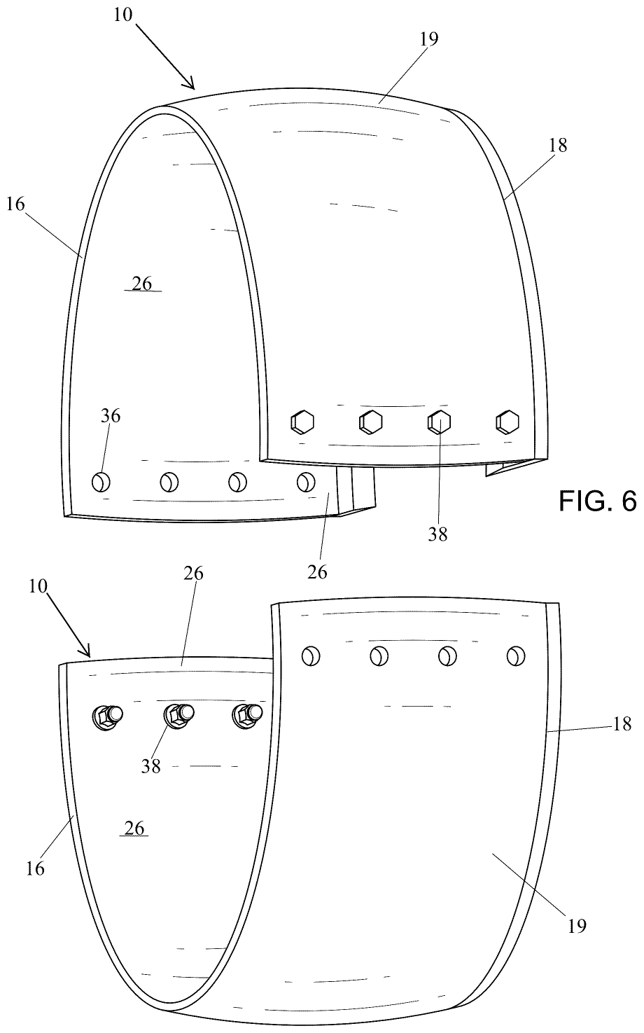

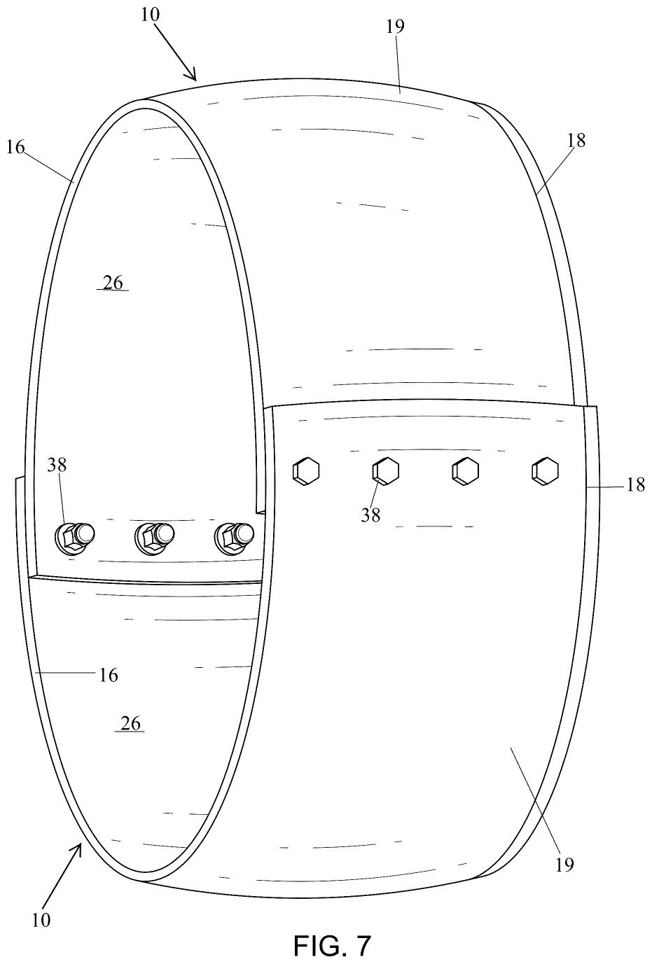

As shown in FIGS. 6 and 7, the garden frame 10 can be installed in a variety of configurations. In some embodiments, the garden framing apparatus 10 can be organized to permit the connection of two garden framing devices such that the devices are in close proximity with each other. This arrangement provides for efficient growing environments and a more efficient placement of the plants 12. In additional embodiments, a garden frame can be reconfigured to suit different applications such as the application of irrigation pipes, tickle or drip irrigation, irrigation controllers, or the same to facilitate the proper maintenance of the plants 12.

A cover can be attached to the top surface 16 to enclose the interior space 28. The sidewall 19 can have a uniform closed configuration or an array of diagonal slit-shaped openings. The sidewall 19 can be extended to overlap the top surface 16 of a single garden frame 10 and provided as overlapping cover panels when a linear arrangement 10 is desired.

Certain components necessary to the operation of the garden framing apparatus are not shown or described in detail because they are components well known to those in the relevant arts. These components can include requisite components and attachments, and adjustment means, support structures, connectors, shade cloths or netting, lighting, and labels.

While the invention has been described in detail and with reference to specific embodiments thereof, it will be apparent to one skilled in the art that various changes and modifications can be made therein without departing from the spirit and scope thereof.

What is claimed is:

1. A garden frame for encasing plants, the garden frame comprising:
a cylindrical structure having a top surface, a bottom surface, a sidewall, and a hollow interior space;
a base fixedly connected to the bottom surface along an inner surface of the sidewall, the base having a beveled edge extending a distance into the hollow interior space of the garden frame;
the sidewall having a first portion with a plurality of perforations and a second portion with a plurality of fastening mechanisms, the perforations aligning with the fastening mechanisms to close the sidewall and enclose the plants in the hollow interior space;
the sidewall being configured in an upright orientation and having a vertical slit defined between the first portion and the second portion, the vertical slit extending from the top surface to the bottom surface;
wherein the first portion of the sidewall overlaps with the second portion of the sidewall when the sidewall is closed, and the base overlaps to form a circular opening at the bottom surface when the first portion overlaps the second portion and the garden frame is closed; and
wherein the plants are loaded into the hollow interior space of the garden frame by closing the vertical slit and securing the first portion to the second portion of the sidewall via the fastening mechanisms, thereby causing the beveled edge of the base to encase the plants against the sidewall of the garden frame.

2. The garden frame of claim 1, wherein the sidewall is flexible and configured to allow rotational and linear adjustment to position and retain the plants within the hollow interior space of the garden frame in an upright configuration.

3. The garden frame of claim 1 wherein the sidewall of the garden frame is comprised of durable and weather-resistant material.

4. A method for enclosing plants using a garden frame, the method comprising the steps of:
providing a garden frame comprising a framing material having an outer cylindrical shape, a top surface, a bottom surface, and the bottom surface being fixedly connected to a base with a beveled edge, sidewall with a hollow interior space, and a first portion having perforations and a second portion with fastening mechanisms;
loading plants into the interior space of the framing material through the circular opening formed by overlapping the first and second portions of the sidewall and causing the beveled edge of the base to encase the plants in the hollow interior space; and
adjusting the flexible framing material to retain the plants at spaced elevations within the garden frame.

5. The method of claim 4, further comprising: providing a durable and weather-resistant framing material for the garden framing apparatus to protect the plants.
